(19) United States
(12) Patent Application Publication
(10) Pub. No.: US 2019/0082666 A1
(43) Pub. Date: Mar. 21, 2019

(54) Ballyhoo/Bait Fish Trolling Hood

(71) Applicant: James A Copeland, Port Saint Lucie, FL (US)

(72) Inventor: James A Copeland, Port Saint Lucie, FL (US)

(21) Appl. No.: 15/711,531

(22) Filed: Sep. 21, 2017

(51) Int. Cl. A01K 83/06; A01K 91/08; A01K 95/00

(52) U.S. Cl. CPC A01K 83/06; A01K 95/00; A01K 91/08

(57) ABSTRACT

A hood like device designed to hold a bait fish while being pulled/trolled through the water imitating a swimming fish. The hood consisting of a weighted spoonbill at the front, attached to a cylinder shaped body in the center and a hallow cone shaped body with the large end facing the rear. An opening from the rear allows line to pass from the rear to the front. The hood is to keep the bait fish in a stable manor and swimming naturally. The line and hook which are separate are there to hold the bait fish in the hood and the hooks catch the fish.

### TECHNICAL FIELD

the invention is in the field of fishing lures that hold bait.

### BACKGROUND OF THE INVENTION

The use of whole small fish for bait “bait fish” is one of the many ways to use bait and is broken into two groups 1, Live fish or 2, Dead and often frozen, then thawed for use. Whole dead bait fish are used differently from live fish. Two methods of trolling them behind watercraft are to make them spin or move erratically through the water imitating a wounded fish, and another method is to pull the dead bait fish imitating live straight swimming fish. In the sport fishing of various predator fish such as mackerel, wahoo, swordfish and the like, it is the practice to present the dead bait fish as a live swimming fish. This is achieved by inserting a hook into the body then secured to the eye of the hook or tying the hook to the head. This is laborious and takes great skill and expertise to provide the desired movement of the bait fish and accordingly provide the greatest enticement for the predator fish. Moreover, such mountings are highly prone to unnatural inversion during trolling.

There are several patented inventions with hoods or mechanism for using bait fish:

### U.S. Patents:

U.S. Pat. No. 8,024,887 B2 Sep. 27, 2011, Milanowski, U.S. Pat. No. 7,257,923 B1, Aug. 21, 2007, Urbano Jr. Has a hood with attachments that rotate the bait fish and cause it to dive, a pin that secures the bait fish, hook, and an eye to attach the line. Rotating the bait fish is not always preferred.

U.S. Pat. No. 6,708,442 B2, Mar. 23, 2004, Kress et al. The hood has metallic covering with eyes and a weight to cause it to submerge. This holds the head of the bait fish and except for the added decoration there is not much advantage.

U.S. Pat. No. 6,658,785 B1, Dec. 9, 2003, Faulkner et al. is minus the hood but has the idea of pulling the bait fish in a straight manor. The apparatus over complicates the process.

U.S. Pat. No. 5,893,232, Apr. 13, 1999, Horton et al. and U.S. Pat. No. 4,067,135, Jan. 10, 1978, to Martin, have hoods, spoonbills, and mechanism to pin the baitfish to the hood, and an eye for line. Design will not keep the bait fish swimming straight.

An invention, the Pirate Plug commercial available designed without a hood and only for ballyhoo.

### SUMMARY OF INVENTION

this present invention allows bait fish to be easily attached to the device and pulled through the water in a straight manor. The device having a weighted spoonbill at the front, that stabilizes and keeps the bait fish upright, attached to a longneck hallow cone shaped body through which the line can pass. The smaller end, the front, houses the shank of a hook followed by a cone shaped body which houses the bend of the hook and the head of bait fish. The barb of the hook extends through a rectangle slot in the top of the cone shaped hood, a slot that runs the long direction of the hood. The bait fish in ideally mounted with a hook through its head with the hook inserted through the lower jaw and out between the eyes. The line that is attached to the hook is passed through the hood from the rear to the front; the head of the bait fish drawn into the hood with the barb of the hook topside. The barb slides into the slot at the top holding the bait fish in place. The line with the hook inside the hood is continues toward the tail of the bait fish with another hook attached. Because the hooks and line are separate if they become damaged they are easily replaced.

According, it is an object to provide a fishing lure that secures the bait fish and keeps it in an upright stable manor when pulled and is easy to use.

### BRIEF DESCRIPTION OF DRAWINGS

These and other features, aspects and advantages of present invention will be better understood with regard to following description, appended claims, and accompanying drawings.

FIG. 1. Is a perspective view of a preferred embodiment of the bait holding hood constructed in accordance with the teachings of the present invention operatively associated with a bait fish line and hook.

FIG. 2. is a front and slightly side view of bait fish holding device.

FIG. 3. is a top and front view of the bait fish holding device.

### DESCRIPTION OF THE PREFERRED EMBODIMENTS

Referring to the drawings for the purposes of illustrating a preferred embodiment only and not for limiting same.

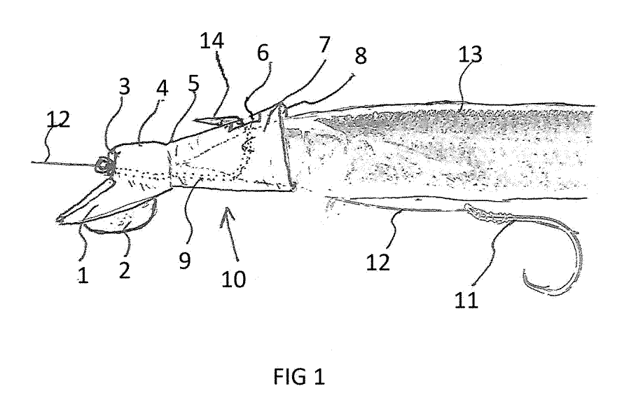

FIG. 1. shows the bait fish hood 10 carrying a bait fish, at the front is a spoonbill 1 with a flat oval surface at a downward angle with a lead weight 2 attached on the underside. An opening 3 extends through to the rear 8. The first segment 4 with the neck 5 has the length to house the shank of the hook 9. Area 5 which has a smaller circumference is to attach attractors. Followed by a cone shaped body 7 with a slot 6 in the top and an opening in the rear 8. The line 12 attached to a hook 9 and is inserted through the head of the bait fish from bottom to top of the head with the barb 14 of the hook 9 extending out the slot 6 in the top of the hood 7. The line 12 continues from the front through the hood 10 to the trailing hook 11.

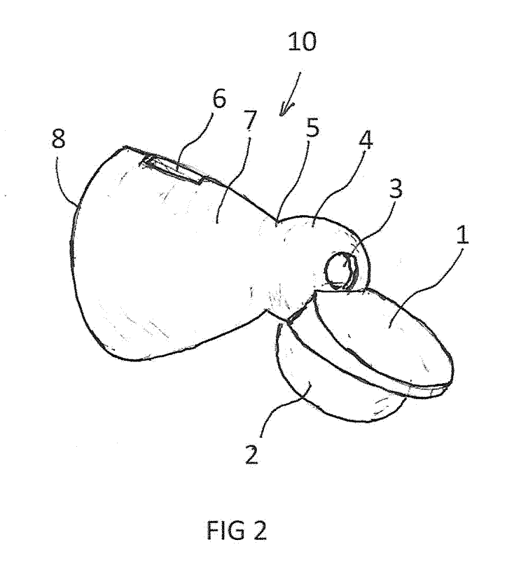

FIG. 2 the front and side view of the hood 10, shows the spoonbill 1 which, when pulled, is designed to force the bait fish downward and has an additional function of causing the bait fish to move from side to side. The lead weight 2 makes the bottom heavier than the top which aids the bait fish to retain its upright position. The opening 3 is a channel that passes through the forward body 4 & 5 into the hollow cone shaped body 7 with a slot in the top 6. The first cylinder shape 4 supports the spoonbill 1 with the neck 5 having a smaller circumference providing an area for attractants to be attached. The distance from the front opening 3 to the cone shaped body 7 creates leverage forward that provides stability and balance.

The slot 6 in the top 7 allows the barb of the hook through the top hood and enables the cone shaped body 7 to more closely fit the head of the bait fish when employing a lager hook.

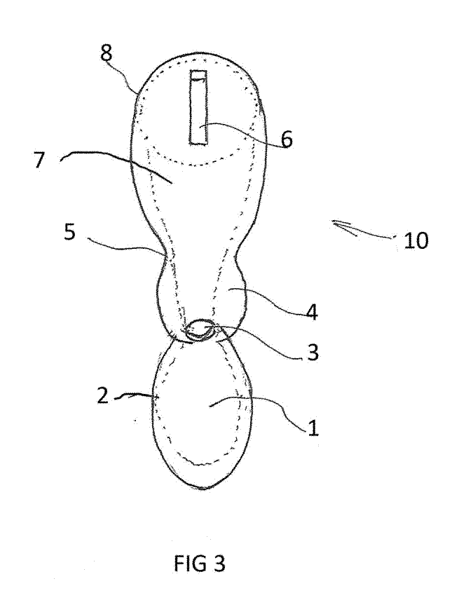

FIG. 3. Showing the outer and inner walls of the hood 10. The rear opening 8 allows the line to be passed through the front opening 3, the shank of the hook is held by the opening through 3, 4 & 5. The head 4 is there to support the spoonbill 1 with the weight 2. The area with the smaller diameter 5 is an area which to attach attractants, or streamers. The cone shaped body 7 holds the head of the bait fish and the bend of the hook. The barb protrudes from the slot opening 6 in the top.

having described the present invention with preferred versions thereof, other versions are possible. The disclosures and description herein are intended to be illustrative and are not in any sense limiting of the invention.

What invention claimed is:

1. A bait fish retaining device, an improved system for securing the head of a bait fish and enabling the bait fish to be pulled through the water in a natural swimming manor comprising: a. a unitary plastic body b. a weighted spoonbill to balance and direct the bait fish c. a hollow cylindrical body to allow the line to pass through d. a hallow cone shaped hood to hold the head of the bait fish e. a slot in the top of the cone shaped hood for the barb of the hook to protrude allowing a better fit of the bait fish head and securing the bait fish.

2. The bait fish retaining device set forth in claim 1, the weighted spoonbill the weight of the lead may vary in weight or shape.

3. The bait fish retaining device set forth in claim 2, the surface of the spoonbill facing front may vary in size and or angle of direction.

4. The bait fish retaining set forth in claim 1, the cylindrical shaped body to have an area with reduced circumference for securing attractants of, but not limited to, squid skirts, nylon hair or feathers.

5. The bait fish retaining device set forth in claim 1, the cone shaped hood to vary and be determined on the size and shape of the bait fish used.

6. The bait fish retaining device set forth in claim 1, to be made of but not limited to plastic and lead or any material that would maintain the integrity of the design.

7. The bait fish retaining device set forth in claim 1, not limited in colors or enhancements directed at targeting specific species of fish
